(19) United States
(12) Patent Application Publication
(10) Pub. No.: US 2025/0353448 A1
(43) Pub. Date: Nov. 20, 2025

(54) GRILLE APPARATUS FOR ELECTRIC VEHICLE

(71) Applicants: HYUNDAI MOTOR COMPANY, SEOUL (KR); KIA CORPORATION, SEOUL (KR); SL CORPORATION, DAEGU (KR)

(72) Inventors: Dong Ha Kim, Hwaseong-si (KR); Jin Young Yoon, Hwaseong-si (KR); Hong Heui Lee, Hwaseong-si (KR); Jun Hyeong Lee, Gyeongsan-si (KR); Seung Gyu Nam, Gyeongsan-si (KR)

(73) Assignees: HYUNDAI MOTOR COMPANY, SEOUL (KR); KIA CORPORATION, SEOUL (KR); SL CORPORATION, DAEGU (KR)

(21) Appl. No.: 18/894,390

(22) Filed: Sep. 24, 2024

(30) Foreign Application Priority Data
May 16, 2024 (KR) 10-2024-0064015

(51) Int. Cl. B60R 11/02; B60R 11/00

(52) U.S. Cl. CPC B60R 11/0235; B60R 11/0217; B60R 2011/004

(57) ABSTRACT

A grille apparatus for an electric vehicle includes a mounting housing provided on an outer surface of the vehicle, a display panel mounted in an open area provided in the mounting housing, and formed to display an image, a withdrawal guide member connected to the display panel and configured to guide the display panel to be selectively withdrawn from the open area according to a set mode, and a grille cover configured to shield the mounting housing and formed to expose the image displayed on the display panel to the outer surface of the vehicle.

### CROSS REFERENCE TO RELATED APPLICATIONS

This application claims under 35 U.S.C. § 119 (a) the benefit of priority to Korean Patent Application No. 10-2024-0064015 filed on May 16, 2024, the entire contents of which are incorporated herein by reference.

### BACKGROUND

### (a) Technical Field

The present disclosure relates to a grille apparatus for an electric vehicle, and more particularly, to a grille apparatus for an electric vehicle, which may enable a display panel to be selectively exposed from the grille apparatus, thereby enabling diverse information to be provided on the exterior of the vehicle.

### (b) Background Art

In general, driving components such as engines as well as various heat exchangers such as radiators, intercoolers, evaporators, and condensers are provided in engine compartments of vehicles.

Inside the heat exchanger, a heat exchange medium typically circulates. Cooling or heat dissipation is achieved through heat exchange between the heat exchange medium inside the heat exchanger and the air outside the same. Thus, for various heat exchangers in the engine compartment of a vehicle to operate stably, outside air should be supplied smoothly into the engine compartment. To this end, a radiator grille, acting as a ventilation hole, is mounted on the front of a radiator.

Furthermore, the radiator grille, positioned at the front of the vehicle, is one of the key components in determining the exterior appearance of vehicles, with distinctive designs influencing overall aesthetics for each vehicle. Thus, the radiator grille becomes an important factor for consumers during vehicle purchasing.

However, for electric vehicles, electric motors replace internal combustion engines for power supply, reducing the functional need of the radiator grille for ventilation.

Nevertheless, as the radiator grille is mounted at the front of the vehicle, it remains a crucial element of vehicle design and has a significant impact on overall aesthetics of the vehicle. Thus, manufacturers have developed grilles with diverse functions and shapes to cater to a wider range of consumer preferences.

However, conventional grilles for vehicles have generally been manufactured and mounted with a structure that limits modification. In some cases, they may be equipped with lighting units, but the shape and design of the grilles have seldom offered easy modification options.

In addition, curved portion included in the grilles makes it difficult to achieve diverse shapes and uniform lighting for lighting units, hindering the creation of a clear image.

### SUMMARY

An objective of the present disclosure is to provide a grille apparatus for an electric vehicle, which may be provided with a mounting housing equipped with a plurality of speakers. A display panel interlocked to the speakers is mounted on the mounting housing such that the display panel is exposed through a transparent cover provided on the front of the grille apparatus, while in a set mode, the display panel is selectively withdrawn from the mounting housing and exposed to the outside of the grille apparatus, thereby enabling the provision of various information on the outside and inside of the grille apparatus.

According to the present disclosure, there is provided a grille apparatus for an electric vehicle, which may include: a mounting housing provided on an outer surface of the vehicle; a display panel mounted in an open area provided in the mounting housing, and formed to display an image; a withdrawal guide member connected to the display panel and configured to guide the display panel to be selectively withdrawn from the open area according to a set mode; and a grille cover configured to shield the mounting housing and formed to expose the image displayed on the display panel to the outer surface of the vehicle.

Here, according to the present disclosure, the grille apparatus for an electric vehicle may further include an upper cover configured to shield the open area, hingedly coupled to the mounting housing, and configured to rotate to expose the open area to the outside.

The upper cover may include a knob, which is provided to be latched in a latching groove formed in the upper portion of the mounting housing, and configured to be disengaged from the latching groove, thereby exposing the open area to the outside.

Meanwhile, the withdrawal guide member may include: a first arm member rotatably connected to a coupling member formed to protrude from the open area; a second arm member rotatably connected to the first arm member; and a third arm member rotatably connected to the second arm member and provided with a connecting member for being connected to the display panel.

In addition, the withdrawal guide member may be received inside the open area, with the first arm member, the second arm member, and the third arm member folded in the mode set to a driving state.

In addition, the withdrawal guide member may cause the first arm member, the second arm member, and the third arm member to be unfolded individually from the coupling member in the mode set to a non-driving state to guide the withdrawal of the display panel from the open area.

In addition, the display panel may include a mounting bracket for being coupled to the connection member. The mounting bracket may be provided with an accommodation member for accommodating a ball member therein formed on the connection member, and be formed to rotate around the ball member acting as an axis.

In addition, the display panel may further include a moving bracket coupled to surround an outer peripheral surface of the mounting bracket and formed to be movable in a front-rear direction of the mounting bracket.

Here, as the display panel is withdrawn from the open area, the connection member may be held in a fixing groove provided in the upper portion of the mounting housing.

In addition, the mounting housing may be provided to include a plurality of LEDs and speakers.

In addition, the grille cover may be formed of a transparent material.

According to the present disclosure, the grille apparatus for an electric vehicle may be provided with the mounting housing equipped with the plurality of the speakers. The display panel interlocked to the speakers is mounted on the mounting housing such that the display panel is exposed through a transparent cover provided on the front of the grille apparatus, while in a set mode, the display panel is selectively withdrawn from the mounting housing and exposed to the outside of the grille apparatus, thereby enabling the provision of various information on the outside and inside of the grille apparatus.

Thus, according to the present disclosure, the grille apparatus for an electric vehicle may provide information for protection of a pedestrian by fixing the display panel when the vehicle is in a stationary state in driving mode, and may also provide information for entertainment through selective withdrawal of the display panel in non-driving mode, thereby offering improved stability and convenience.

### BRIEF DESCRIPTION OF THE FIGURES

FIG. 1 is a view illustrating a coupled state of a grille apparatus for an electric vehicle according to an embodiment of the present disclosure.

FIG. 2 is a view illustrating a separated state of the grille apparatus for an electric vehicle according to an embodiment of the present disclosure.

FIG. 3 is a view illustrating an image on a display panel in driving mode of the grille apparatus for an electric vehicle according to an embodiment of the present disclosure.

FIG. 4A is a view illustrating opening of an upper cover of the grille apparatus for an electric vehicle according to an embodiment of the present disclosure.

FIG. 4B is an enlarged view illustrating area A of FIG. 4A to illustrate a knob of the grille apparatus for an electric vehicle according to an embodiment of the present disclosure.

FIG. 5 is a view illustrating rotation of the display panel of the grille apparatus for an electric vehicle according to an embodiment of the present disclosure.

FIG. 6A is a view illustrating a withdrawal state of the display panel of the grille apparatus for an electric vehicle according to an embodiment of the present disclosure.

FIG. 6B is an enlarged view illustrating area B of FIG. 6A illustrating a withdrawal guide member of the grille apparatus for an electric vehicle according to an embodiment of the present disclosure.

FIG. 7 is a view illustrating a configuration of the withdrawal guide member of the grille apparatus for an electric vehicle according to an embodiment of the present disclosure.

FIG. 8 is a view illustrating a fixing groove of the grille apparatus for an electric vehicle according to an embodiment of the present disclosure.

FIG. 9 is a view illustrating a mounting bracket of the grille apparatus for an electric vehicle according to an embodiment of the present disclosure.

FIG. 10 is a view illustrating shielding of the upper cover of the grille apparatus for an electric vehicle according to an embodiment of the present disclosure.

FIG. 11 is a view illustrating an image on the display panel in non-driving mode of the grille apparatus for an electric vehicle according to an embodiment of the present disclosure.

### DETAILED DESCRIPTION

Embodiments of the present disclosure will be described in detail below with reference to the accompanying drawings.

The advantages and features of the present disclosure, and methods of accomplishing the same will become clear with reference to the following detailed description of the embodiments with accompanying drawings.

However, the present disclosure should not be construed as being limited to the embodiments described herein, but may be embodied in various different forms. The present embodiments are merely provided to make the present disclosure complete and to completely explain the scope of the present disclosure to those skilled in the art. The present disclosure should be determined by the appended claims.

Furthermore, in certain embodiments, a detailed description of well-known related art may be omitted to avoid obscuring appreciation of the disclosure by those skilled in the art.

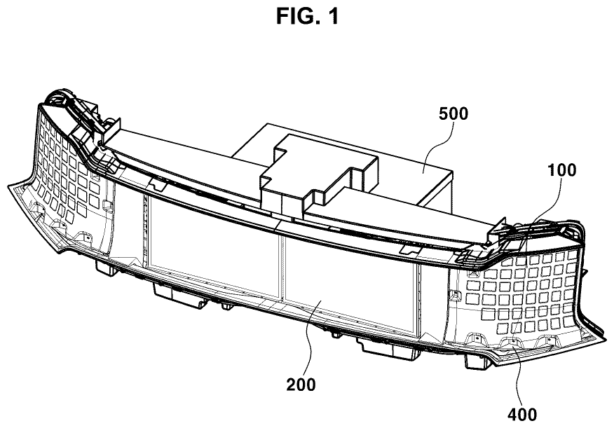

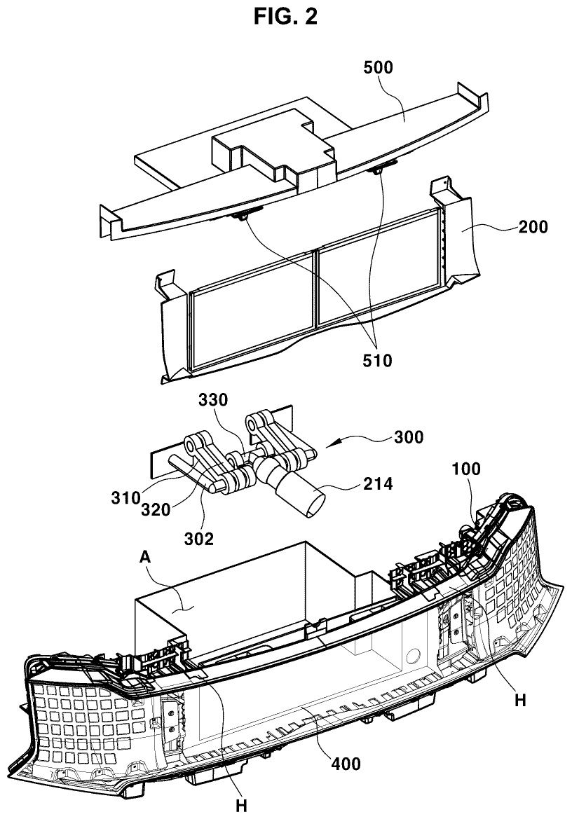

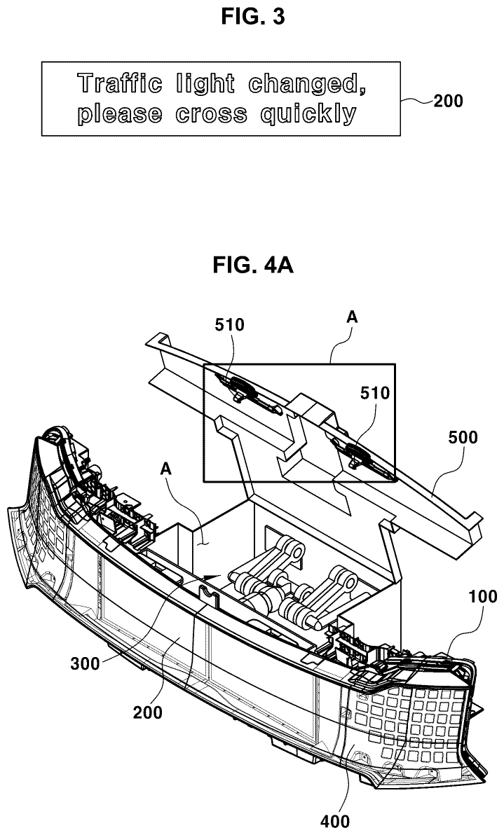

FIG. 1 is a view illustrating a coupled state of a grille apparatus for an electric vehicle according to an embodiment of the present disclosure, and FIG. 2 is a view illustrating a separated state of the grille apparatus for an electric vehicle according to an embodiment of the present disclosure. FIG. 3 is a view illustrating an image on a display panel in driving mode of the grille apparatus for an electric vehicle according to an embodiment of the present disclosure.

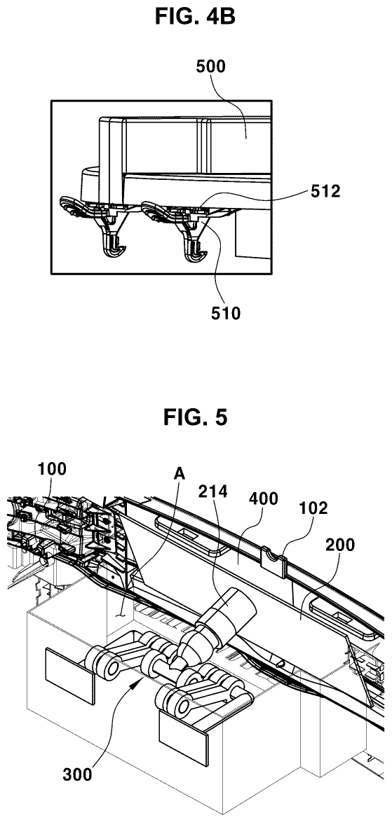

FIG. 4A is a view illustrating opening of an upper cover of the grille apparatus for an electric vehicle according to an embodiment of the present disclosure. FIG. 4B is an enlarged view illustrating area A of FIG. 4A to illustrate a knob of the grille apparatus for an electric vehicle according to an embodiment of the present disclosure.

As illustrated in FIGS. 1 and 2, the grille apparatus for an electric vehicle according to the present embodiments includes a mounting housing 100, a display panel 200, a withdrawal guide member 300, and a grille cover 400.

The mounting housing 100 is illustrated as being provided on a front surface of the vehicle, but this is by way of illustration and not limitation. The mounting housing 100 may also be provided on the outer surface of the vehicle, more specifically, on the rear surface of the bumper, on the side door, or the like.

More preferably, the mounting housing 100 may include an open area A provided in the center portion thereof, a plurality of LEDs for forming a conventional lighting means, and a plurality of speakers (not illustrated) connected to the display panel 200 on both sides of the open area A.

In general, as a vehicle is equipped with an internal combustion engine in the front portion of a vehicle body, the required cooling capacity for the front portion of the vehicle body is relatively large. Thus, for the vehicle equipped with the internal combustion engine, a bumper cover has an upper grille formed in the upper area and a lower grille formed in the lower area.

On the other hand, as an electric vehicle is not equipped with an internal combustion engine in the front portion of a vehicle body, the required cooling capacity for the front portion of the vehicle body is relatively low. Thus, for the electric vehicle, the upper area of a bumper cover is closed, and a lower grille is formed in the lower area of the bumper cover.

In such a structure of the front portion of the vehicle body of the electric vehicle, the open area A provided in the mounting housing 100 is formed in the upper area thereof. The front portion of the open area A is formed in an open shape, and thus the open area A, along with the LEDs and the like, may be shielded by the grille cover 400. In the same way, the upper portion of the open area A is formed in an open shape, and thus the open area A may be shielded by an upper cover 500, which will be described later.

The display panel 200 is mounted in the open area A and is configured to display an image on the front of the vehicle through the grille cover 400.

As illustrated in FIG. 3, the display panel 200 may display on a screen information for conveying a traffic signal, such as “Traffic light changed, please cross quickly,” to a pedestrian in a driving state or in driving mode set to a stationary state.

And, for example, the display panel 200 may display advertisement information, speed information, or the like on the screen.

In addition, the display panel 200 may display emergency dispatch information, route information, or reservation status information on the screen depending on the type of specific-purpose vehicle such as an ambulance, bus, or taxi.

In addition, the display panel 200 may display battery charging status information, remaining battery information, estimated charging time information, and the like on the screen when the vehicle is in a stationary state for charging.

The information output through the screen of the display panel 200 is not limited to the above examples; both a video and a still screen may be output. The information output through the screen may be easily set or changed according to user convenience or purpose.

The withdrawal guide member 300 is connected to the display panel 200 and guides the display panel 200 to be selectively withdrawn from the open area A, for example, in non-driving mode set to a parked or stationary state rather than in a driving state.

Here, the withdrawal guide member 300 may cause the display panel 200 to be placed inside the open area A as a plurality of arms are arranged in a folded state, and may also cause the display panel 200 to be exposed to the outside of the open area A as the plurality of the arms are arranged to be unfolded in non-driving mode.

As the plurality of the arms may be individually unfolded with the withdrawal guide member 300 being connected to the display panel 200 through a mounting bracket 210, the withdrawal guide member 300 may adjust a movable distance of the display panel 200 along a front-rear direction, and, together with the mounting bracket 210, may allow the arrangement angle of the display panel 200 to be adjusted.

The grille cover 400 is provided to shield the mounting housing 100 including the plurality of the LEDs for forming a conventional lighting means, and is formed such that the image displayed on the display panel 200 is exposed to the front of the vehicle through the open area A.

Preferably, the grille cover 400 may be formed of a transparent material such that the displayed image may pass therethrough and be exposed.

More specifically, the grille cover 400 may be formed of a transparent material, but the center portion for shielding the open area A and two side portions for shielding the LEDs may be formed of different materials, thereby allowing the luminance of the image displayed via the display panel 200 to be adjusted accordingly.

On the other hand, the grille apparatus for an electric vehicle according to the present embodiment may further include the upper cover 500 for shielding the upper part of the open area A.

As illustrated in FIG. 4A, the upper cover 500 is hingedly coupled to the mounting housing 100 and configured to rotate to expose the open area A to the outside.

As a knob 510, which is latched in a latching groove H formed in the upper portion of the mounting housing 100, is disengaged, the upper cover 500 rotates in the mounting housing 100 to expose the open area A, in which the display panel 200 is arranged, to the outside, thereby providing an environment for the display panel 200 to be withdrawn from the open area A.

As illustrated in FIG. 4B, a pair of the knobs 510 may be provided in the lower portion of the upper cover 500, and may be configured to overcome an elastic force of an elastic member 512 provided on each of the knobs 510 and rotate in the lower portion of the upper cover 500 to be disengaged from the latching groove H such that the upper cover 500 rotates.

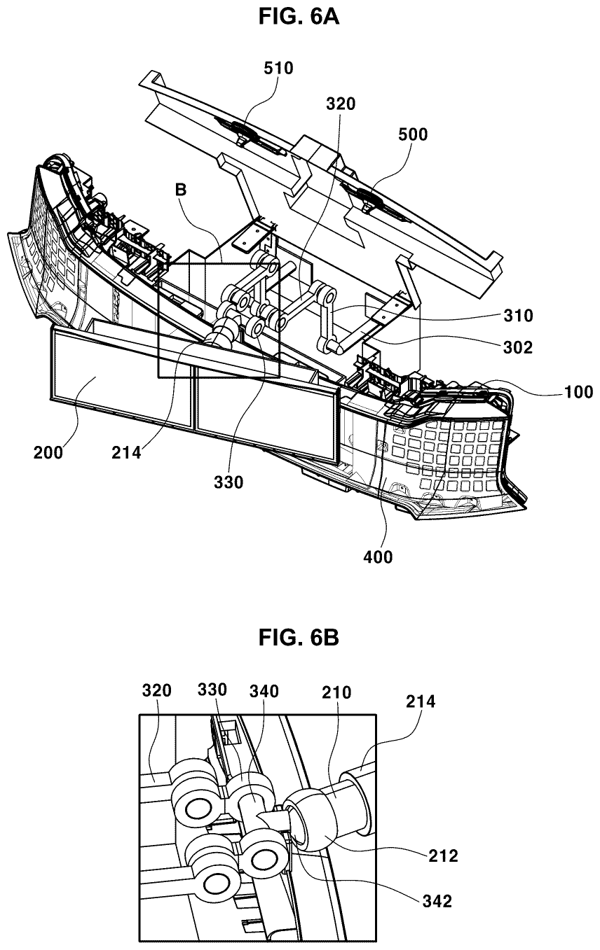

In addition, FIG. 5 is a view illustrating rotation of the display panel of the grille apparatus for an electric vehicle according to an embodiment of the present disclosure. FIG. 6A is a view illustrating a withdrawal state of the display panel of the grille apparatus for an electric vehicle according to an embodiment of the present disclosure. FIG. 6B is an enlarged view illustrating area B of FIG. 6A illustrating a withdrawal guide member of the grille apparatus for an electric vehicle according to an embodiment of the present disclosure.

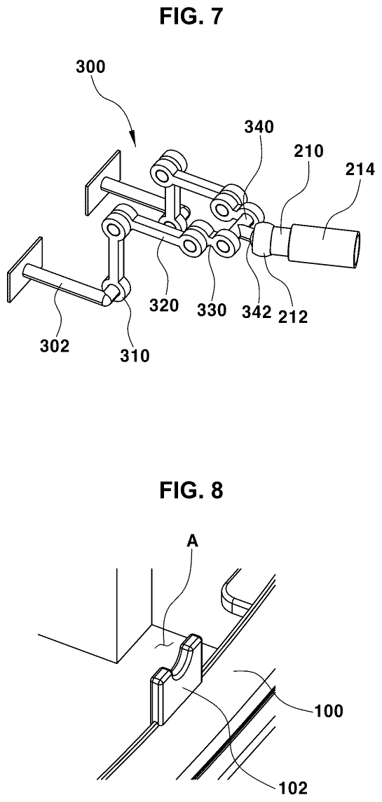

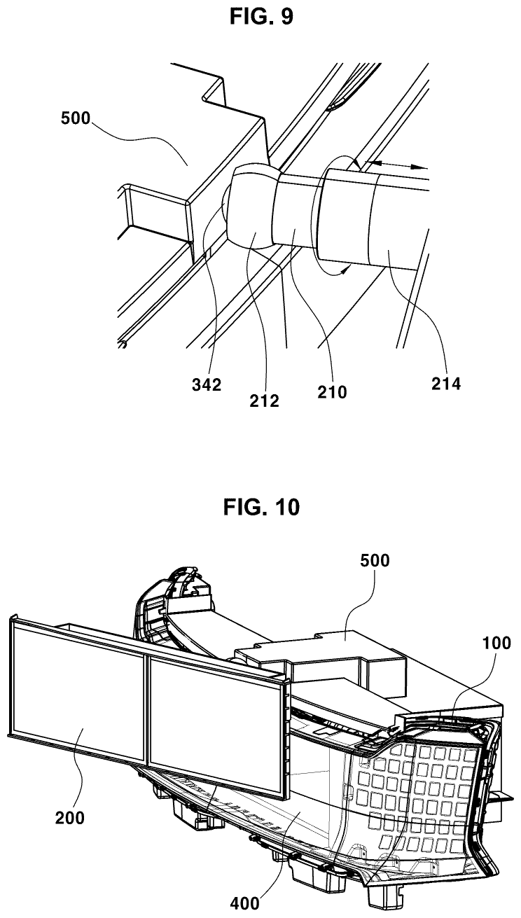

In addition, FIG. 7 is a view illustrating a configuration of the withdrawal guide member of the grille apparatus for an electric vehicle according to an embodiment of the present disclosure. FIG. 8 is a view illustrating a fixing groove of the grille apparatus for an electric vehicle according to an embodiment of the present disclosure. FIG. 9 is a view illustrating a mounting bracket of the grille apparatus for an electric vehicle according to an embodiment of the present disclosure.

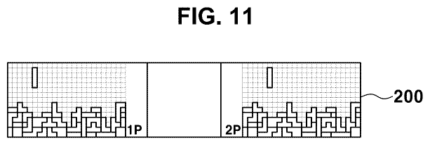

In addition, FIG. 10 is a view illustrating shielding of the upper cover of the grille apparatus for an electric vehicle according to an embodiment of the present disclosure. FIG. 11 is a view illustrating an image on the display panel in non-driving mode of the grille apparatus for an electric vehicle according to an embodiment of the present disclosure.

When the display panel 200 is separated from the mounting housing 100 by the withdrawal guide member 300 as illustrated in FIG. 5, the display panel 200 may be withdrawn from the open area A as illustrated in FIG. 6A.

To this end, the withdrawal guide member 300 is provided with first arm members 310, second arm members 320, and third arm members 330 as illustrated in FIG. 7.

Ends of the first arm members 310 are rotatably connected to a pair of coupling members 302, respectively, formed to protrude from the open area A, and the other ends of the first arm members 310 are rotatably connected to the second arm members 320, respectively.

In addition, the second arm members 320 are formed to have the same shape and length as the first arm members 310. As similarly described above, ends of the second arm members 320 are rotatably connected to the other ends of the first arm members 310, respectively, and the other ends of the second arm members 320 are rotatably connected to the third arm members 330, respectively.

In addition, ends of the third arm members 330 are rotatably connected to the other ends of the second arm members 320, respectively, as similarly described above, and the other ends of the third arm members 330 are rotatably connected to the connection member 340 for being connected to the display panel 200.

Each of the first arm members 310, the second arm members 320, and the third arm members 330 may rotatably move individually.

That is, when the first arm members 310, the second arm members 320, and the third arm members 330 are folded, the withdrawal guide member 300 may be minimized in length, thereby causing the display panel 200 to be received inside the open area A. When the first arm members 310 and the second arm members 320 are arranged to form a right angle, and the third arm members 330 are unfolded from the second arm members 320, the withdrawal guide member 300 may cause the display panel 200 to be withdrawn from the open area A.

More specifically, in a mode set to a driving state, when the first arm members 310, the second arm members 320, and the third arm members 330 are folded, the withdrawal guide member 300 may be received inside the open area A, thereby exposing the screen of the display panel 200, through the grille cover 400. In a mode set to a non-driving state, the first arm members 310, the second arm members 320, and the third arm members 330 are individually unfolded from the coupling member 302, and the withdrawal guide member 300 guides the withdrawal of the display panel 200 from the open area A (see FIG. 6A), thereby exposing the screen of the display panel 200 withdrawn from the open area A.

Here, the content output through the screen of the display panel 200 as described above may be entertainment information, as illustrated in FIG. 11. Accordingly, in driving mode, an image such as conveying information to a pedestrian is output through the grille cover 400, thereby providing convenience to another vehicle or the pedestrian. In non-driving mode set to a parked state or the like, an entertainment image may be selectively output, thereby providing enjoyment to a user by utilizing the image output through the display panel 200 in situations such as parking or camping.

Meanwhile, the display panel 200 is provided with the mounting bracket 210 for being coupled to the connection member 340 (see FIGS. 2 and 7), and the mounting bracket 210 is provided with an accommodation member 212 for accommodating a ball member 342 therein, formed in the connection member 340 as illustrated in FIG. 6B. Such a coupling structure may enable the mounting bracket 210 to rotate around the ball member 342 acting as an axis.

In addition, the display panel 200 may further include a moving bracket 214, which is coupled to surround an outer peripheral surface of the mounting bracket 210 and thus is formed to be movable in a front-rear direction of the mounting bracket 210.

Thus, in non-driving mode, when the display panel 200 is withdrawn from the open area A, the open area A is shielded by the upper cover 500, and then the mounting bracket 210 may be rotated, by coupling of the ball member 342 and accommodation member 212, at various angles as illustrated in FIG. 9. Thus, the arrangement angle of the display panel 200 coupled to the mounting bracket 210 may vary depending on the user's line of sight.

In addition, as the moving bracket 214 may be movable in the front-rear direction on the mounting bracket 210, the distance between the display panel 200 and the grille cover 400 may be selectively adjusted while the display panel 200 is received in the open area A.

In addition, as the display panel 200 is withdrawn from the open area A in non-driving mode, the connection member 340 may be held in a fixing groove 102, provided in the upper portion of the mounting housing 100, as illustrated in FIG. 8.

Accordingly, as the connection member 340 is held in the fixing groove 102, the display panel 200, while withdrawn from the open area A, may only be angularly adjustable, but not movable in the horizontal direction.

In addition, the movement of the connection member 340 in the vertical direction may be restricted by the upper cover 500 (see FIG. 9). Thus, in non-driving mode, when the display panel 200 is withdrawn as illustrated in FIG. 10, the display panel 200 may be fixed in a three-stage withdrawal position formed by the unfolding of the first arm members 310, the second arm members 320, and the third arm members 330, thereby enabling stable use of the display panel 200 outside the mounting housing 100.

According to the present disclosure, the grille apparatus for an electric vehicle may be provided with the mounting housing equipped with the plurality of the speakers. The display panel interlocked to the speakers is mounted on the mounting housing such that the display panel is exposed through a transparent cover provided on the front of the grille apparatus, while in a set mode, the display panel is selectively withdrawn from the mounting housing and exposed to the outside of the grille apparatus, thereby enabling the provision of various information on the outside and inside of the grille apparatus.

Thus, according to the present disclosure, the grille apparatus for an electric vehicle may provide information for protection of a pedestrian by fixing the display panel when the vehicle is in a stationary state in driving mode, and may also provide information for entertainment through selective withdrawal of the display panel in non-driving mode, thereby offering improved stability and convenience.

While the present disclosure has been described above with reference to the embodiments illustrated in the drawings, the embodiments are described just for illustration, and those skilled in the art will understand that various modifications of the embodiments may be made, and all or some of the described embodiments may be selectively combined. Accordingly, the true technical protection scope of the present disclosure should be determined by the technical spirit of the appended claims.

1. A grille apparatus for an electric vehicle comprising:
a mounting housing positioned on an outer surface of the electric vehicle;
a display panel mounted in an open area positioned in the mounting housing, and configured to display an image;
a withdrawal guide member connected to the display panel and configured to guide the display panel to be withdrawn from the open area according to a set mode; and
a grille cover configured to shield the mounting housing and configured to expose the image displayed on the display panel to the outer surface of the electric vehicle.

2. The grille apparatus of claim 1, further comprising an upper cover configured to shield the open area, the upper cover being hingedly coupled to the mounting housing, and the upper cover being configured to rotate to expose the open area to an outside.

3. The grille apparatus of claim 2, wherein the upper cover comprises a knob configured to be latched in a latching groove formed in an upper portion of the mounting housing, and configured to be disengaged from the latching groove, thereby exposing the open area to the outside.

4. The grille apparatus of claim 1, wherein
the withdrawal guide member comprises:
a first arm member rotatably connected to a coupling member protruding from the open area;
a second arm member rotatably connected to the first arm member; and
a third arm member rotatably connected to the second arm member and including a connecting member for being connected to the display panel.

5. The grille apparatus of claim 4, wherein the withdrawal guide member is received inside the open area, with the first arm member, the second arm member, and the third arm member being folded in a mode set to a driving state.

6. The grille apparatus of claim 4, wherein the withdrawal guide member causes the first arm member, the second arm member, and the third arm member unfold individually from the coupling member in a mode set to a non-driving state to guide withdrawal of the display panel from the open area.

7. The grille apparatus of claim 4, wherein the display panel comprises a mounting bracket for being coupled to the connection member, and
wherein the mounting bracket includes an accommodation member for accommodating a ball member formed on the connection member, the accommodation member being formed to rotate around the ball member acting as an axis.

8. The grille apparatus of claim 7, wherein the display panel further comprises a moving bracket coupled to surround an outer peripheral surface of the mounting bracket and configured to be movable in a front-rear direction of the mounting bracket.

9. The grille apparatus of claim 4, wherein the connection member is held in a fixing groove provided in the upper portion of the mounting housing as the display panel is withdrawn from the open area.

10. The grille apparatus of claim 1, wherein the mounting housing comprises a plurality of LEDs and speakers.

11. The grille apparatus of claim 1, wherein the grille cover is formed of a transparent material.
